(19) United States
(12) Patent Application Publication
(10) Pub. No.: US 2014/0360189 A1
(43) Pub. Date: Dec. 11, 2014

(54) INTEGRATED SEPARATOR TURBINE

(71) Applicants: Harry F. Miller, Allegany, NY (US); Pascal Lardy, Notre Dame du Bec. (FR); Michael S. Cormier, Santa Rosa, CA (US); William C. Maier, Almond, NY (US)

(72) Inventors: Harry F. Miller, Allegany, NY (US); Pascal Lardy, Notre Dame du Bec. (FR); Michael S. Cormier, Santa Rosa, CA (US); William C. Maier, Almond, NY (US)

(73) Assignee: DRESSER-RAND COMPANY, Olean, NY (US)

(21) Appl. No.: 14/285,732

(22) Filed: May 23, 2014

Related U.S. Application Data
(60) Provisional application No. 61/831,653, filed on Jun. 6, 2013.

(51) Int. Cl. F01K 21/06; F03G 7/04

(52) U.S. Cl. CPC F01K 21/06; F03G 7/04
USPC 60/645; 122/488; 60/641.2

(57) ABSTRACT

A fluid processing system and method are provided for separating a liquid portion from a multiphase fluid. The system and method may include a steam turbine assembly coupled with a rotary shaft, and a separator coupled with the rotary shaft and positioned upstream of the steam turbine assembly. The separator may include an inlet end configured to receive a multiphase fluid, an outlet end fluidly coupled with the steam turbine assembly, and a separation chamber extending from the inlet end to the outlet end. The separation chamber may be configured to separate a liquid portion from the multiphase fluid to thereby provide a substantially gaseous fluid to the steam turbine assembly.

### CROSS-REFERENCE TO RELATED APPLICATIONS

This application claims priority to U.S. Provisional Patent Application Ser. No. 61/831,653, filed on Jun. 6, 2013. This priority application is hereby incorporated by reference in its entirety into the present application to the extent consistent with the present application.

### BACKGROUND

A conventional steam turbine assembly may include a plurality of rotor blades or buckets disposed about and coupled with a rotary shaft. The steam turbine assembly may be generally configured to extract energy from a fluid stream (e.g., steam) flowing therethrough via the rotor blades and convert the energy into work via rotation of the rotary shaft. The fluid stream, however, may often include a multiphase fluid of liquid water and steam that may decrease efficient operation of the steam turbine assembly. Additionally, the liquid water entrained with the steam may further contain minerals and other particulates dissolved and/or dispersed therein that may impose harsh operational conditions on the steam turbine assembly and/or components thereof. In order to extend the effective lifetime of the steam turbine assembly and/or components thereof (e.g., rotor blades), it is often desirable to separate the liquid and/or solid phases (e.g., liquid water and/or minerals) from the multiphase fluid prior to its introduction into the steam turbine assembly, such that the fluid stream introduced thereto is composed of a substantially gaseous fluid (i.e., steam).

In view of the foregoing, a static separator is often disposed upstream of and fluidly coupled with the steam turbine assembly to separate the liquid and solid phases from the multiphase fluid (e.g., solids from fluids, liquids from gases). The static separator may be a gravity, vanepack, or cyclonic type separator, where the liquid and solid phases may be separated from the fluid stream and subsequently collected.

In many cases, a single static separator may be insufficient for separating the liquid and solid phases from the multiphase fluid contained in the fluid stream. For example, when the multiphase fluid stream includes an increased concentration of the liquid and solid phases, the liquid and solid phases may flow through swirler vanes of the static separator without being entrained within the swirled fluid stream. Accordingly, the multiphase fluid stream may not be directed toward a separation surface of the static separator, thereby resulting in the insufficient separation of the liquid and solid phases from the multiphase fluid stream. As such, multiple static separators may often be disposed in series upstream of the steam turbine assembly to incrementally separate the liquid and solid phases from the multiphase fluid stream. The use of multiple static separators with the steam turbine assembly, however, increases cost and results in a larger operative footprint for the steam turbine assembly. Additionally, the use of multiple static separators in conjunction with the steam turbine assembly also increases routine maintenance and repair thereof.

What is needed, then, is an efficient and compact fluid processing system and method capable of removing high-density fluids and other particulate matter from multiphase fluids for a steam turbine assembly.

### SUMMARY

Embodiments of the disclosure may provide a fluid processing system. The fluid processing system may include a steam turbine assembly coupled with a rotary shaft and a separator coupled with the rotary shaft and positioned upstream of the steam turbine assembly. The separator may include an inlet end configured to receive a multiphase fluid, an outlet end fluidly coupled with the steam turbine assembly, and a separation chamber extending from the inlet end to the outlet end. The separation chamber may be configured to separate a liquid portion from the multiphase fluid to thereby provide a substantially gaseous fluid to the steam turbine assembly.

Embodiments of the disclosure may further provide another fluid processing system including a steam turbine assembly and a rotary separator. The steam turbine may include a rotary shaft, rotor blades disposed about the rotary shaft and coupled therewith, and stator vanes disposed circumferentially about the rotary shaft and positioned upstream of the rotor blades. The stator vanes may define an end wall passage extending from an inlet to an outlet of the stator vanes. The rotary separator may be coupled with the rotary shaft of the steam turbine assembly and positioned directly upstream of the steam turbine assembly. The rotary separator may include an inlet end configured to receive a multiphase fluid, an outlet end fluidly coupled with the steam turbine assembly, and a separation chamber extending from the inlet end to the outlet end. The separation chamber may be configured to separate a liquid portion from the multiphase fluid to thereby provide a substantially gaseous fluid to the steam turbine assembly.

Embodiments of the disclosure may further provide a method for separating a liquid portion from a multiphase fluid for a fluid processing system. The method may include receiving the multiphase fluid from a fluid source at an inlet end of a rotary separator fluidly coupled with the fluid source. The method may also include rotating a rotary shaft, the rotary shaft common to the rotary separator and a steam turbine assembly positioned downstream of the rotary separator. The method may further include separating the liquid portion from the multiphase fluid in a separation chamber of the rotary separator to provide a substantially gaseous fluid. The method may also include directing the substantially gaseous fluid directly to an inlet of a steam turbine assembly via an outlet end of the rotary separator.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a high level schematic view of an exemplary fluid processing system, according to one or more embodiments disclosed.

FIG. 2 illustrates an axial cross-sectional view of an exemplary rotary separator that may be included in the exemplary fluid processing system of FIG. 1, according to one or more embodiments disclosed.

FIG. 3 illustrates a partial cross-sectional view of an exemplary steam turbine assembly that may be included in the exemplary fluid processing system of FIG. 1, according to one or more embodiments disclosed.

FIG. 4 illustrates a partial cross-sectional view of another exemplary fluid processing system including an exemplary rotary separator and an exemplary steam turbine assembly, according to one or more embodiments disclosed.

FIG. 5 is a flowchart of an illustrative method for separating a liquid portion from a multiphase fluid used in a fluid processing system, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

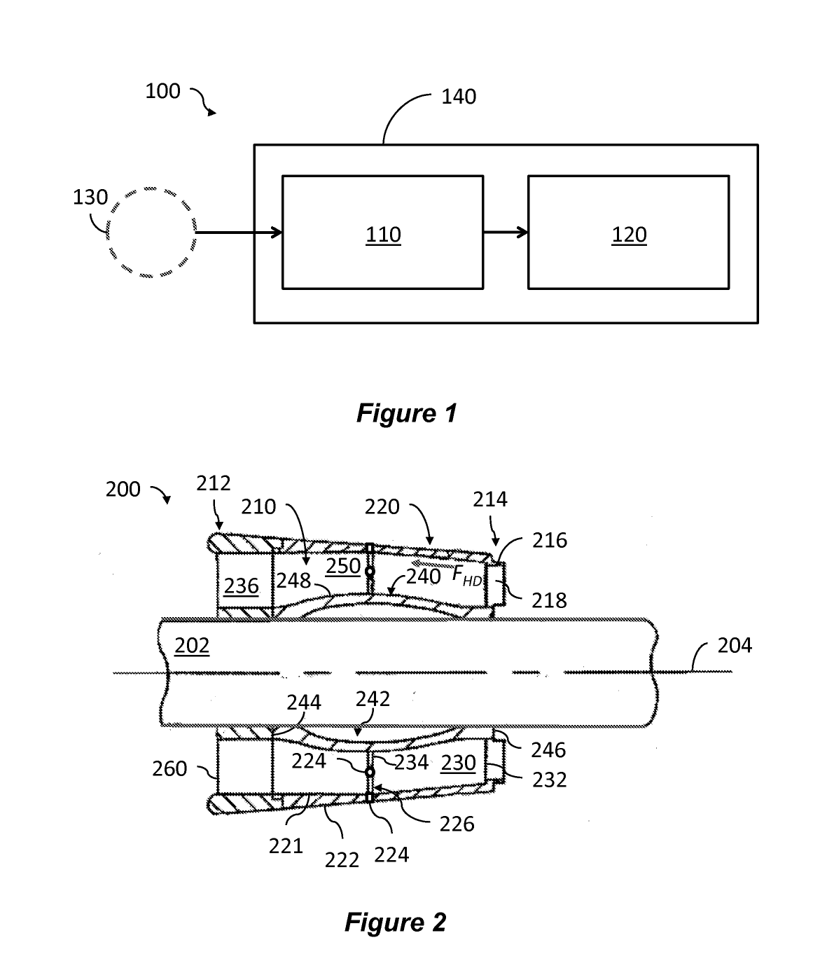

FIG. 1 illustrates a high level schematic view of an exemplary fluid processing system 100, according to one or more embodiments. The fluid processing system 100 may include a first stage assembly 110 and a second stage assembly 120. In at least one embodiment, the first stage assembly 110 and the second stage assembly 120 may be coupled together via a common rotary shaft. The rotary shaft may include a single segment or multiple segments coupled together via one or more gears. In at least one embodiment, illustrated in FIG. 1, the first stage assembly 110 and the second stage assembly 120 may be disposed and sealed (e.g., hermetically sealed) in a common housing 140. In another embodiment, the first stage assembly 110 and the second stage assembly 120 may be individually disposed and sealed in separate housings.

The first stage assembly 110 of the fluid processing system 100 may include an inlet fluidly coupled with a fluid source 130 and configured to receive a fluid stream therefrom. The first stage assembly 110 may also include an outlet fluidly coupled with an inlet of the second stage assembly 120 of the fluid processing system 100. The fluid stream may be or include a multiphase fluid having a plurality of phases of varying densities. For example, the fluid stream may include one or more liquids and/or gases of varying densities. In at least one embodiment, the fluid source 130 may be or include a geothermal source and the fluid stream may be or include a geothermal fluid stream. The geothermal fluid stream may include a multiphase fluid having a plurality of phases of varying densities. For example, the geothermal fluid stream may include a gaseous phase (i.e., steam) and a liquid phase (i.e., water). Additionally, in at least one embodiment, the geothermal fluid stream may include a solid phase. In at least one embodiment, the geothermal fluid stream may also include one or more minerals, which may be combined with the gaseous phase and/or the liquid phase thereof. For example, the minerals may be dispersed and/or dissolved in the liquid phase, thereby providing mineral water. Accordingly, the geothermal fluid stream may include steam and mineral water.

As further described herein, the first stage assembly 110 may be or include a separator (e.g., rotary separator) and the second stage assembly 120 may be or include a steam turbine assembly. The separator may receive the fluid stream (e.g., geothermal fluid stream), separate at least a portion of the high-density fluids and/or particulates (e.g., water and/or minerals) from the fluid stream, and direct the remaining portion of the fluid stream to the steam turbine assembly. In at least one embodiment, the separator may separate the high-density fluids and/or particulates from the fluid stream to provide a substantially gaseous fluid and direct the substantially gaseous fluid to the steam turbine assembly.

FIG. 2 illustrates an axial cross-sectional view of a separator 200 that may be used in the exemplary fluid processing system 100 of FIG. 1, according to one or more embodiments. For example, the separator 200 may be included in the first stage assembly 110 of the fluid processing system 100 and may comprise a rotary separator. The separator 200 may be disposed about and coupled with a rotary shaft 202. The separator 200 may include an interior separation chamber 210 axially extending from an inlet end 212 to an outlet end 214. The separator 200 may be fluidly coupled with the fluid source 130 such that the fluid stream may be directed to the inlet end 212 thereof. In at least one embodiment, as previously described, the fluid stream may be or include a multiphase fluid having phases of varying densities. For example, the fluid stream may include one or more liquids and/or gases of varying densities. The separator 200 may receive the fluid stream at the inlet end 212, separate at least a portion of the high-density fluids (e.g., liquids) from the fluid stream in the separation chamber 210, and direct the remaining portions (e.g., gas) of the fluid stream to the outlet end 214 thereof. For example, the separator 200 may receive the fluid stream at the inlet end 212 and separate a portion of the liquids from the fluid stream to provide a substantially gaseous fluid, which may be directed to the outlet end 214 thereof.

The separator 200 may include an end contact surface or portion 216 located proximal to the outlet end 214 and extending circumferentially about a longitudinal axis 204 of the rotary shaft 202. In at least one embodiment, the end contact surface 216 may be disposed proximal to an inlet of the second stage assembly 120 of the fluid processing system 100, thereby defining an interface therebetween. For example, the end contact surface 216 may be disposed proximal to an inlet of a steam turbine assembly, as further described herein. The end contact surface 216 of the separator 200 may be coupled with the inlet of the second stage assembly 120 of the fluid processing system 100 such that a fluid tight seal may be provided at the interface, thereby preventing or substantially preventing the separated or “dried” fluid stream from flowing outwardly through the interface. Similarly, the separated high-density fluids (e.g., liquids) may be prevented or substantially prevented from flowing inwardly through the interface.

In at least one embodiment, the end contact surface 216 of the separator 200 may include an offset protrusion or lip 218 extending axially toward the inlet of the second stage assembly 120 of the fluid processing system 100. The lip 218 may provide at least a portion of the end contact surface 216 and may be sized to mate or couple with the inlet of the second stage assembly 120 of the fluid processing system 100 such that the end contact surface 216 may be disposed within and against an inlet contact surface of the second stage assembly 120, as further described herein. In at least one embodiment, radial outward expansion of the separator 200 during rotation thereof may cause the lip 218 to sealingly engage the inlet contact surface of the second stage assembly 120. The engagement between the lip 218 and the inlet contact surface of the second stage assembly 120 may prevent or substantially prevent the separated or “dried” fluid stream from flowing outwardly through the interface and/or the separated high-density fluids from flowing inwardly through the interface.

While embodiments disclosed herein describe coupling the separator 200 with the second stage assembly 120 via the interface and/or lip 218, it may be appreciated that the separator 200 may be coupled with the second stage assembly 120 in any other appropriate manner (e.g., radial flanges) to provide fluid communication therebetween. Additionally, it may be appreciated that the separator 200 may be integrally formed with the second stage assembly 120 of the fluid processing system 100, as further described herein.

In at least one embodiment, the separator 200 may include a generally tubular body 220 having inner and outer circumferential surfaces 221, 222. The inner circumferential surface 221 may define the separation chamber 210, which may be configured to separate the high-density fluids (e.g., liquids) from low density fluids (e.g., gases) contained in the fluid stream. In at least one embodiment, the body 220 may include one or more discharge ports or openings 224, the body defining the discharge ports 224, and the discharge ports 224 may radially extend from the inner circumferential surface 221 to the outer circumferential surface 222. The discharge ports 224 may be configured to provide a passage for channeling the high-density fluids out of the separation chamber 210. The high-density fluids channeled out of the separation chamber 210 may be subsequently collected in a vessel (not shown) having a level-controlled drain valve (not shown).

In at least one embodiment, the inner circumferential surface 221 of the tubular body 220 may include a generally annular groove 226 that is defined by the inner circumferential surface 221 of the tubular body 220. The annular groove 226 may extend radially outward from the inner circumferential surface 221 toward the outer circumferential surface 222. One or more of the discharge ports 224 may be disposed in the annular groove 226 and may extend from the annular groove 226 of the inner circumferential surface 221 to the outer circumferential surface 222 of the tubular body 220. The annular groove 226 may provide a collection trough for the high-density fluids flowing proximal to the inner circumferential surface 221 of the tubular body 220. For example, during the rotation of the separator 200, the high-density fluids may be directed to the inner circumferential surface 221 of the tubular body 220 and may collect in the annular groove 226. The high-density fluids collected in the annular groove 226 may be subsequently discharged from the rotary separator 200 via the discharge ports 224 disposed therein.

In at least one embodiment, the inner circumferential surface 221 may include a generally frustoconical portion or section 230 having a first edge portion 232 positioned proximal the outlet end 214 of the separator 200. The first edge portion 232 may be spaced axially from and may have a circumference relatively smaller than a second edge portion 234. In at least one embodiment, the frustoconical portion 230 may extend through the axial length of the tubular body 220 and may taper from the inlet end 212 to the outlet end 214. For example, the second edge portion 234 of the frustoconical portion 230 may be located proximal the inlet end 212 of the separator 200. In another embodiment, the frustoconical portion 230 may extend through a portion of the axial length of the tubular body 220 and, in one embodiment, may taper from the annular groove 226 to the outlet end 214. For example, as illustrated in FIG. 2, the second edge portion 234 of the frustoconical portion 230 may be located proximal the annular groove 226 of the separator 200 and the frustoconical portion 230 may taper from the annular groove 226 toward the outlet end 214. As illustrated in FIG. 2, the orientation or position of the first edge portion 232 proximal the outlet end 214 in combination with the smaller circumference thereof, as compared to the second edge portion 234, may direct or urge at least a portion of the high-density fluids (F_{HD}) contacting the frustoconical portion 230 near or about the first edge portion 232 toward the second edge portion 234. Accordingly, the high-density fluids (F_{HD}) contacting the frustoconical portion 230 may be directed from the outlet end 214 to the annular groove 226.

In at least one embodiment, the inner circumferential surface 221 may also include a generally cylindrical portion or section 236 extending from the inlet end 212 of the separator 200 toward the annular groove 226. The cylindrical portion 236 may have an inner diameter defined by the inner circumferential surface 221 of the tubular body 220. In at least one embodiment, the inner diameter of the cylindrical portion 236 may be constant from the inlet end 212 to the annular groove 226. The orientation of the frustoconical portion 230 and the cylindrical portion 236 may direct the flow of the high-density fluids in the fluid stream toward the annular groove 226 of the separator 200 during rotation thereof. Accordingly, the high-density fluids directed toward the annular groove 226 may collect therein and may be subsequently flowed or directed out of the separator 200 via the discharge ports 224 disposed therein.

In at least one embodiment, a tubular inner deflector member 240 may be coupled with the rotary shaft 202 and disposed within the separation chamber 210. The deflector member 240 may include a through bore 242 extending from a first axial end 244 to a second axial end 246. The deflector member 240 may include an outer surface 248 that may be curved radially outward toward the inner circumferential surface 221 of the tubular body 220, relative to the rotary shaft 202. The outer surface 248 of the deflector member 240 may be spaced or disposed radially inward from the inner circumferential surface 221 of the tubular body 220 to define an annular flow channel 250 extending through the separator 200. In at least one embodiment, the high-density fluids in the fluid stream contacting the outer surface 248 of the deflector member 240 may be directed toward the inner circumferential surface 221 of the tubular body 220.

In at least one embodiment, the separator 200 may include a plurality of blades 260 disposed proximal to the inlet end 212 thereof and configured to accelerate the fluid stream entering the separator 200. For example, the rotation of the rotary shaft 202 may rotate the blades 260 coupled with the separator 200, and energy from the rotation of the rotary shaft 202 may be transferred to at least a portion of the fluid stream contacting the blades 260. The transfer of energy from the rotary shaft 202 to the fluid stream via the blades 260 may thereby accelerate the fluid stream through the annular flow channel 250 of the separator 200.

While embodiments disclosed herein describe a particular separator 200, it may be appreciated that the separator included in the first stage assembly 110 of the fluid processing system 100 may be embodied by other types of separators. For example, the first stage assembly 100 of the fluid processing system 100 may include the rotary separator described in commonly assigned U.S. Pat. No. 7,241,392, the contents of which are hereby incorporated by reference to the extent consistent with the present disclosure. Additional exemplary rotary separators that may be utilized in the first stage assembly 110 of the fluid processing system 100 may include those described in commonly assigned U.S. Pat. Nos. 8,302,779 and 8,580,002, the contents of each hereby incorporated by reference to the extent consistent with the present disclosure.

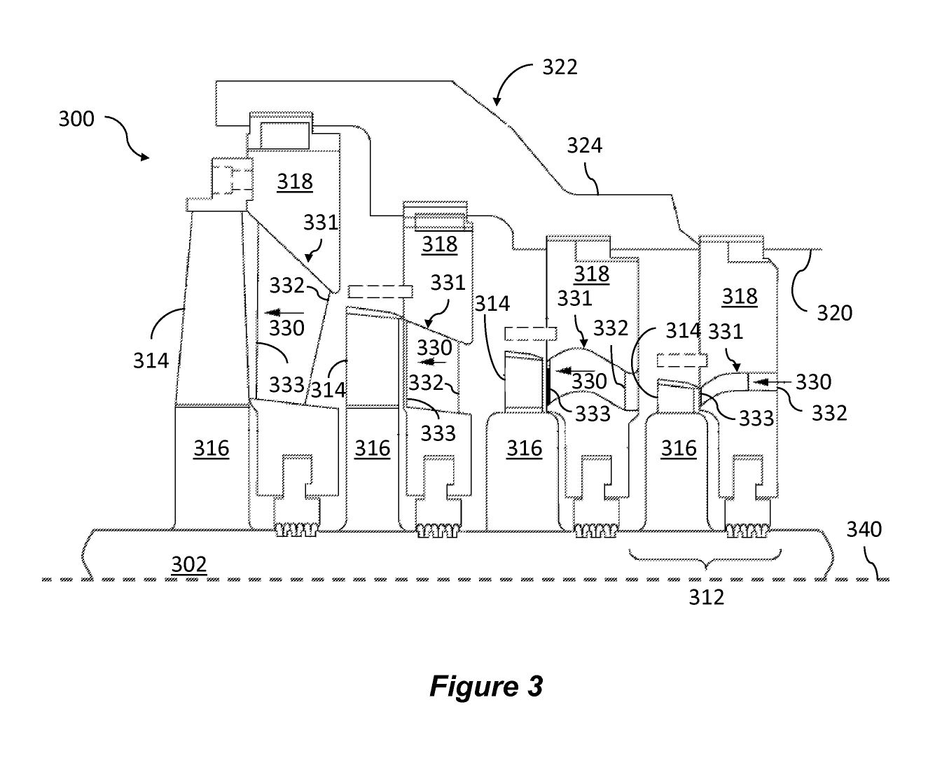

FIG. 3 illustrates a partial cross-sectional view of an exemplary steam turbine assembly 300 that may be included in the exemplary fluid processing system 100 of FIG. 1, according to one or more embodiments. For example, the steam turbine assembly 300 may be included in the second stage assembly 120 of the fluid processing system 100 illustrated in FIG. 1. In at least one embodiment, the steam turbine assembly 300 may be a multistage steam turbine, as shown in FIG. 3. The steam turbine assembly 300 may include a plurality of stages where a first stage 312 of the plurality of stages may include a set of rotor blades 314 axially spaced from and interleaved with a set of stator vanes 318. As illustrated in FIG. 3, the first stage 312 may be followed by one or more succeeding stages to provide the multistage steam turbine. The rotor blades 314 may be symmetrically disposed about and coupled with a rotary shaft 302 configured to rotate about a central axis 340 of the steam turbine assembly 300. In at least one embodiment, each of the rotor blades 314 may include a root 316 configured to couple the rotor blades 314 with the rotary shaft 302. The stator vanes 318 may be disposed radially outward of the rotary shaft 302 and coupled with an inner surface 320 of a casing or housing 322 of the steam turbine assembly 300. In at least one embodiment, each of the stator vanes 318 may define an end wall passage 331 extending from an inlet 332 to an outlet 333 and configured to direct a fluid stream into the rotor blades 314 disposed downstream thereof.

In operation, a fluid stream (e.g., steam) may flow through the plurality of stages of the rotor blades 314 and the stator vanes 318, as indicated by arrows 330. For example, the fluid stream 330 may be directed to the inlet 332 of each stator vane 318 and the fluid stream 330 may flow along the end wall passages 331 from the inlets 332 to the outlets 333. As the fluid stream 330 flows through the plurality of stages, the end wall passages 331 of the stator vanes 318 may direct the fluid stream 330 to contact the rotor blades 314, thereby rotating the rotor blades 314 and the rotary shaft 302 coupled therewith. In at least one embodiment, a power generator (not shown) may be coupled with the steam turbine assembly 300 via the rotary shaft 302 and configured to convert the rotational energy into electrical energy. The electrical energy may be transferred or delivered from the power generator to an electrical grid (not shown) via a power outlet (not shown) coupled therewith.

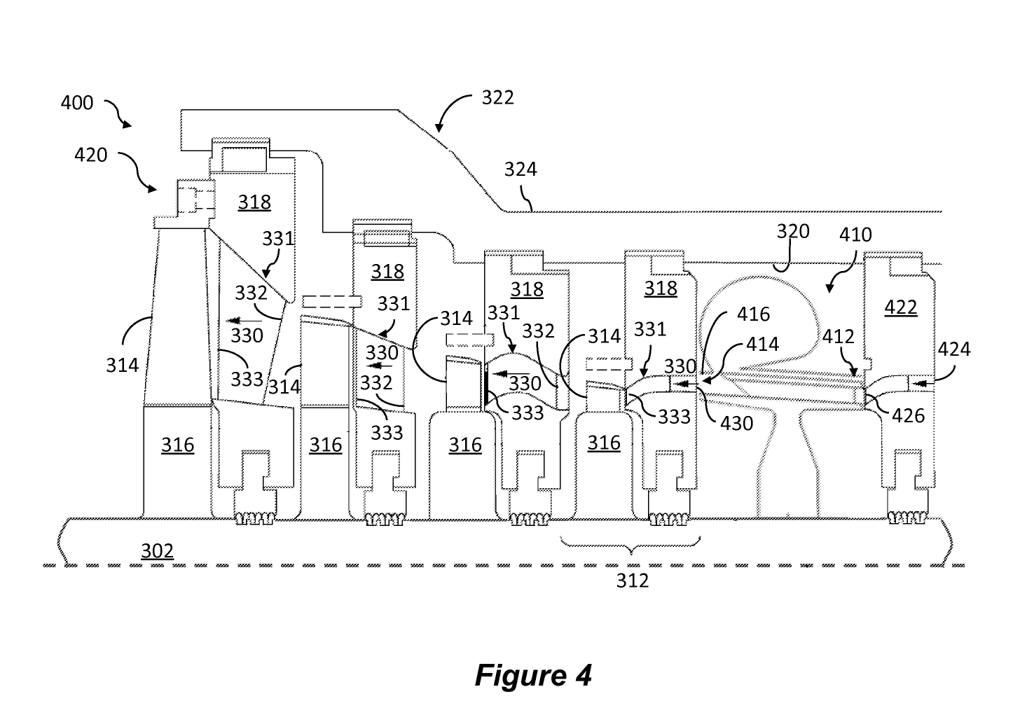

FIG. 4 illustrates a partial cross-sectional view of an exemplary fluid processing system 400 including an exemplary separator 410 and an exemplary steam turbine assembly 420, according to one or more embodiments. The fluid processing system 400, the separator 410, and the steam turbine assembly 420 may be similar in some respects to the fluid processing system 100, the separator 200, and the steam turbine assembly 300 described above, and therefore may be best understood with reference to the description of FIGS. 1-3 where like numerals designate like components and will not be described again in detail.

In at least one embodiment, the steam turbine assembly 420 may be a multistage steam turbine, as shown in FIG. 4, and the separator 410 may be a rotary separator that is fluidly coupled with the steam turbine assembly 420. As illustrated in FIG. 4, the separator 410 may be disposed directly upstream of the first stage 312 of the steam turbine assembly 420, and an outlet end 414 of the separator 410 may be fluidly coupled with an inlet 430 of the first stage 312 of the steam turbine assembly 420. In at least one embodiment, the inlet 430 of the first stage 312 of the steam turbine assembly 420 may be fluidly coupled with the outlet end 414 of the separator 410 via one or more annular sections, conduits, and/or lines (not shown). In another embodiment, the inlet 430 of the steam turbine assembly 420 may be directly coupled with the outlet end 414 of the separator 410. For example, an end contact surface 416 of the separator 410 may be disposed proximal to the inlet 430 of the steam turbine assembly 420. In at least one embodiment, the outlet end 414 of the separator 410 may generally extend about the inlet 430 of the steam turbine assembly 420. In another embodiment, the outlet end 414 of the separator 410 may be at least partially disposed within the inlet 430 of the steam turbine assembly 420. Accordingly, the end contact surface 416 of the separator 410 may be disposed within an inner surface defining at least a portion of the inlet 430 of the steam turbine assembly 420. For example, an offset protrusion or lip (not shown) of the separator 410 may be sized to mate or couple within the inlet 430 of the steam turbine assembly 420. In another embodiment, the separator 410 may be integrally formed with the steam turbine assembly 420 as opposed to being fixedly or detachably coupled therewith. For example, the outlet end 414 of the separator 410 may be integrally formed with the inlet 430 of the steam turbine assembly 420.

As illustrated in FIG. 4, the fluid processing system 400 may include a nozzle 422 disposed directly upstream of an inlet end 412 of the separator 410. The nozzle 422 may have an inlet 424 fluidly coupled with a fluid source (not shown) and an outlet 426 fluidly coupled with the inlet end 412 of the separator 410. In at least one embodiment, the nozzle 422 may be configured to receive a fluid stream from the fluid source at the inlet 424 thereof and direct the fluid stream to the inlet end 412 of the separator 410 via the outlet 426 thereof.

As previously discussed, the first stage assembly 110 (e.g., rotary separator) and the second stage assembly 120 (e.g., steam turbine assembly) of the fluid processing system 100 may be coupled with one another via a common rotary shaft. For example, any one of the separators 200, 410 described herein may have a rotary shaft and any one of the steam turbine assemblies 300, 420 described herein may be coupled with the rotary shaft of any one of the separators 200, 410. Similarly, any one of the steam turbine assemblies 300, 420 described herein may have a rotary shaft and any one of the separators 200, 410 described herein may be coupled with the rotary shaft of any one of the steam turbine assemblies 300, 420. For example, as illustrated in FIG. 4, the separator 410 may be coupled with the rotary shaft 302 of the steam turbine assembly 420. In another embodiment, the rotary shaft of any one of the separators 200, 410 may be coupled with the rotary shaft of any one of the steam turbine assemblies 300, 420. For example, the rotary shaft of any one of the separators 200, 410 may be coupled with the rotary shaft of any one of the steam turbine assemblies 300, 420 via one or more gears (not shown).

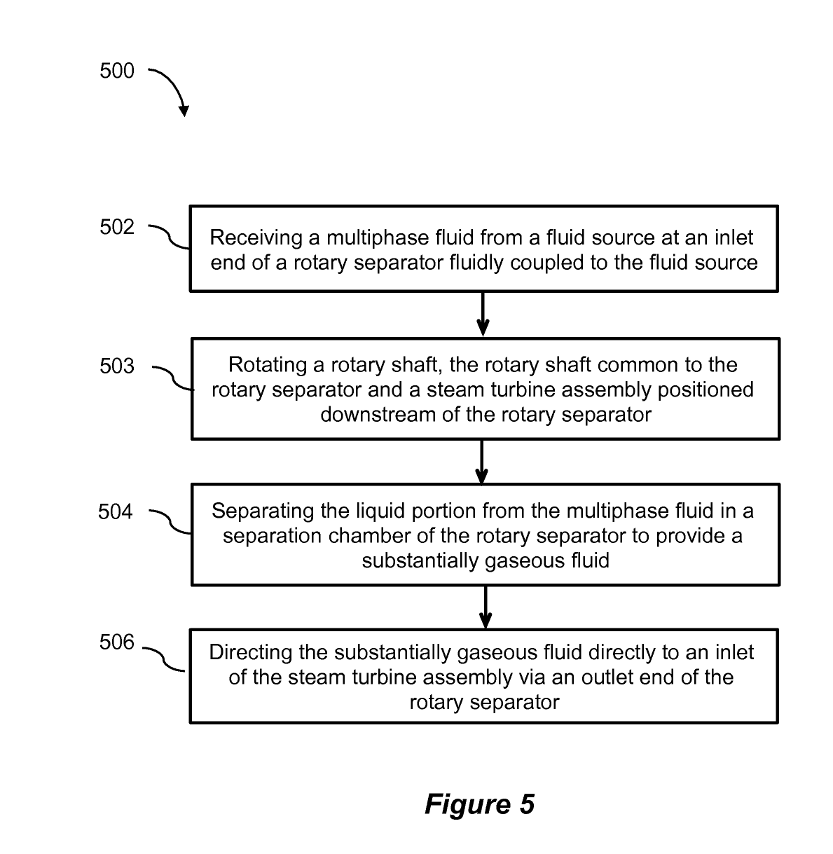

FIG. 5 is a flowchart of an illustrative method 500 for separating a liquid portion from a multiphase fluid for a fluid processing system, according to one or more embodiments. The method 500 may include receiving a multiphase fluid from a fluid source at an inlet end of a rotary separator fluidly coupled therewith, as shown at 502. The method 500 may also include rotating a rotary shaft, the rotary shaft common to the rotary separator and a steam turbine assembly positioned downstream of the rotary separator, as shown at 503. The method 500 may further include separating a liquid portion from the multiphase fluid in a separation chamber of the rotary separator to provide a substantially gaseous fluid, as shown at 504. The method 500 may also include directing the substantially gaseous fluid directly to an inlet of a steam turbine assembly via an outlet end of the rotary separator, as shown at 506.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A fluid processing system, comprising:
a steam turbine assembly coupled with a rotary shaft; and
a separator coupled with the rotary shaft and positioned upstream of the steam turbine assembly, the separator comprising:
an inlet end configured to receive a multiphase fluid,
an outlet end fluidly coupled with the steam turbine assembly, and
a separation chamber extending from the inlet end to the outlet end, the separation chamber configured to separate a liquid portion from the multiphase fluid to thereby provide a substantially gaseous fluid to the steam turbine assembly.

2. The fluid processing system of claim 1, wherein the separator is a rotary separator.

3. The fluid processing system of claim 1, wherein the multiphase fluid comprises a geothermal fluid.

4. The fluid processing system of claim 1, wherein the steam turbine assembly and the separator are disposed in a common housing.

5. The fluid processing system of claim 1, wherein the separator further comprises a tubular body defining the separation chamber, the tubular body including an inner and outer circumferential surface and an annular groove defined by the inner circumferential surface thereof, the annular groove at least partially extending radially outward from the inner circumferential surface towards the outer circumferential surface of the tubular body.

6. The fluid processing system of claim 5, wherein the separator further comprises a deflector member coupled with the rotary shaft, the deflector member including an outer surface spaced radially inward from the inner circumferential surface of the tubular body, relative to the rotary shaft, and configured to direct the liquid portion toward the inner circumferential surface.

7. The fluid processing system of claim 5, wherein the tubular body defines a plurality of discharge ports, each discharge port radially extending from the inner circumferential surface to the outer circumferential surface.

8. The fluid processing system of claim 7, wherein the plurality of discharge ports are disposed in the annular groove.

9. The fluid processing system of claim 1, wherein the steam turbine assembly comprises:
rotor blades disposed about the rotary shaft and coupled therewith; and
stator vanes disposed circumferentially about the rotary shaft and positioned upstream of the rotor blades, the stator vanes defining an end wall passage extending from an inlet of the stator vanes to an outlet of the stator vanes, the inlet of the stator vanes configured to receive the substantially gaseous fluid from the separator, and the end wall passage configured to direct the substantially gaseous fluid to the rotor blades.

10. The fluid processing system of claim 9, wherein the separator is coupled with the rotary shaft directly upstream of the stator vanes of the steam turbine assembly.

11. A fluid processing system, comprising:
a steam turbine assembly comprising:
a rotary shaft,
rotor blades disposed about the rotary shaft and coupled therewith, and
stator vanes disposed circumferentially about the rotary shaft and positioned upstream of the rotor blades, the stator vanes defining an end wall passage extending from an inlet to an outlet of the stator vanes; and
a rotary separator coupled with the rotary shaft of the steam turbine assembly and positioned directly upstream of the steam turbine assembly, the rotary separator comprising:
an inlet end configured to receive a multiphase fluid,
an outlet end fluidly coupled with the steam turbine assembly, and
a separation chamber extending from the inlet end to the outlet end, the separation chamber configured to separate a liquid portion from the multiphase fluid to thereby provide a substantially gaseous fluid to the steam turbine assembly.

12. The fluid processing system of claim 11, wherein the rotary shaft is a single segment.

13. The fluid processing system of claim 11, wherein the rotary shaft comprises multiple segments coupled together by at least one gear.

14. The fluid processing system of claim 11, wherein the multiphase fluid comprises a geothermal fluid.

15. The fluid processing system of claim 11, wherein the steam turbine assembly and the rotary separator are disposed in a common housing.

16. The fluid processing system of claim 11, wherein the rotary separator further comprises a tubular body, the tubular body including an inner and outer circumferential surface and an annular groove defined by the inner circumferential surface, the annular groove at least partially extending radially outward from the inner circumferential surface towards the outer circumferential surface of the tubular body.

17. The fluid processing system of claim 16, wherein the rotary separator further comprises a deflector member coupled with the rotary shaft, the deflector member having an outer surface spaced radially inward from the inner circumferential surface of the tubular body, relative to the rotary shaft, and configured to direct the liquid portion toward the inner circumferential surface.

18. The fluid processing system of claim 17, wherein the tubular body defines a plurality of discharge ports, each discharge port radially extending from the inner circumferential surface to the outer circumferential surface.

19. The fluid processing system of claim 18, wherein the plurality of discharge ports are disposed in the annular groove.

20. A method for separating a liquid portion from a multiphase fluid for a fluid processing system, comprising:
receiving the multiphase fluid from a fluid source at an inlet end of a rotary separator fluidly coupled with the fluid source;
rotating a rotary shaft, the rotary shaft common to the rotary separator and a steam turbine assembly positioned downstream of the rotary separator;
separating the liquid portion from the multiphase fluid in a separation chamber of the rotary separator to provide a substantially gaseous fluid; and
directing the substantially gaseous fluid directly to an inlet of the steam turbine assembly via an outlet end of the rotary separator.
